(19) United States
(12) Patent Application Publication
(10) Pub. No.: US 2005/0102204 A1
(43) Pub. Date: May 12, 2005

(54) Potential financial statement preparation system

(76) Inventor: Masakazu Kataoka, Tokyo (JP)

Correspondence Address: Norman P. Soloway;HAYES SOLOWAY PC, 130 W. Cushing Street, Tucson, AZ, 85701, US

(21) Appl. No.: 10/852,919

(22) Filed: May 25, 2004

(30) Foreign Application Priority Data
Nov. 11, 2003 (JP) 2003-381206
Feb. 20, 2004 (JP) 2004-044626

(51) Int. Cl. G06F 17/60

(52) U.S. Cl. 705/30

(57) ABSTRACT

A potential financial statement preparation system modifies ordinary financial statements of a firm conforming to accounting principles by adding thereto potential debt, potential asset, potential capital, potential revenue, potential cost, manager capital etc. to prepare potential financial statements. The potential financial statements include information useful to persons interested in the firm, such as creditors, shareholders, investors, manager and employees of the firm.

### FIELD OF THE INVENTION

The present invention relates to a potential financial statement preparation system and, more particularly, to a potential financial statement preparation system for preparing a series of financial statements, which are especially useful for creditor, shareholder (investor) and manager, based on the financial statements conforming to accounting principles.

The financial statements of a firm provide the information of the firm necessary for decision-making by interested persons around the firm. The financial statements are prepared based on the accounting principles generally accepted as fair and reasonable principles, and disclose therein the assets, debts and capital belonging to the firm as well as full contents of the revenue, cost and profit generated as the results of operation by the firm. The interested persons can recognize the contents of a variety of profits and net assets (capital stock and reserves on the book value) of the firm, such as the revenue and profit after tax, based on the financial statements. It is to be noted that the term “financial statements” as used herein include balance sheet and profit-and-loss statement (P/L statement), which are generally recognized as typical financial statements.

FIG. 5 shows exemplified balance sheet and P/L statement as conventional financial statements. The balance sheet shows the state of assets at a specified time point such as the date of closing account of the firm. The balance sheet discloses the kinds and amounts of the assets held by the firm on the debit side or left column, and the situation of fundraise on the credit side or right column while revealing the resource and the amount of each fund. The right side is also divided into top and bottom portions, wherein the top portion shows the debt (debt in the book value) and the bottom portion shows the capital (capital in the book value). The unit of the amount of money shown in FIG. 5 is ten thousand dollars, for example.

The P/L statement reveals the profit or loss during an accounting period concerned therewith. Although there are some other representations, the P/L statement exemplified in FIG. 5 discloses on the left column (debit side) the costs and profits of the firm generated during the subject period and also discloses on the right column (credit side) the amount of sales and other revenues of the firm generated during the accounting period.

The financial statements conforming to the accounting principles are generally prepared based on the concept of realization and distribution. In such a case, the balance sheet and the P/L statement reveal, in principle, the amounts of the asset, debt and capital expressed on the book value, together with the profit and cost. Although the principles of “current value accounting” and “asset-impairment accounting” are being sometimes introduced in the financial statements to more clearly reveal the contents, such accountings are considered as anomalistic or exceptional procedures, and the accounting in the book value does not obstacle the current recognition of the accounting principles as a whole. The financial statements conforming to the accounting principles are thus widely used by the creditors concerned with the firm dealings (hereinafter referred to as general creditors), central and local governments, employees and general residents as well as by the investors (shareholders) and creditors concerned with the finance for the firm (hereinafter referred to as simply creditors).

It is to be noted that the financial statements conforming to the accounting principles do not always reveal the necessary information, which each interested person concerned with the firm does desire, because the contents of the financial statements are determined by the uniform accounting principles. For example, a creditor who has made a loan to the firm, an investor (shareholder) who has invested or intends to invest in the firm and the entrepreneur (or manager) who now manages the firm need more detailed information in addition to the information revealed in the financial statements prepared in a blanket procedure, and yet the information desired by the interested persons varies depending on the situation of the interested persons.

Conventionally, each interested person concerned with the firm collects, in addition to the financial statements of the firm, other information thereof by himself, or calculates various indexes by using financial analysis, for making the necessary judgement based on the other information or the various indexes. In short, the conventional financial statements conforming to the accounting principles only provide limited information. If the interested persons can use new, improved financial statements which include the information desired by each interested person, the business activity will be performed more effectively.

### SUMMARY OF THE INVENTION

In view of the above problems of the conventional financial statements as described heretofore, it is an object of the present invention to provide a potential financial statement preparation system, which is capable of preparing new, improved financial statements, referred to as “potential financial statements” in this text, and providing the information desired by each interested person in a formulated manner.

The present invention provides, in a first aspect thereof, a potential financial statement preparation system including: an input section for receiving information of ordinary financial statements of a firm conforming to accounting principles and other information of the firm; and an information processing section for adding, to the ordinary financial statements, at least a potential debt ΔD existing in a financial debt, a potential asset ΔA existing in a financial asset, a potential capital ΔV existing in a shareholder's capital value, and a potential asset ΔV′ existing in the shareholder's capital value, each of which exists as viewed by a creditor and is calculated based on the ordinary financial statements and the other information, to thereby prepare first potential financial statements.

The present invention provides, in a second aspect thereof, a potential financial statement preparation system including: an input section for receiving information of ordinary financial statements of a firm conforming to accounting principles and other information of the firm; and an information processing section for adding, to the ordinary financial statements, at least a potential debt (ΔD+ΔD′) existing in a financial debt, a potential asset ΔA existing in a financial asset, a potential capital ΔV existing in a shareholder's capital value and a potential asset ΔV″ existing in the shareholder's capital value, each of which exists as viewed by a shareholder and calculated based on the ordinary financial statements and the other information, to thereby prepare potential financial statements.

The present invention provides, in a third aspect thereof, a potential financial statement preparation system including: an input section for receiving information of ordinary financial statements of a firm conforming to accounting principles and other information of the firm; and an information processing section for adding, to the ordinary financial statements, at least a potential debt (ΔD+ΔD′) existing in a financial debt, a potential asset ΔA existing in a financial asset, a potential asset ΔV″ existing in the shareholder's capital value, each of which exists as viewed by a shareholder and calculated based on the ordinary financial statements and the other information, and first and second portions (x and ME) of a potential capital ΔV existing in a shareholder's capital value as viewed by the shareholder and calculated based on the ordinary financial statements and the other information, the first and second portions (x and ME) relating to the shareholder's capital and a manager capital, respectively, to thereby prepare potential financial statements.

In accordance with the potential financial statement preparation systems of the present invention, the variety of potential financial statements prepared by the potential financial statement preparation systems reveal the information desired by respective interested persons including creditors, shareholders (investors) and manager of the firm, whereby the interested persons can make optimum decisions based on the information of the respective potential financial statements.

The above and other objects, features and advantages of the present invention will be more apparent from the following description, referring to the accompanying drawings.

### BRIEF DESCRIPTION OF THE DRAWINGS

FIG. 1 exemplifies creditor-dedicated potential financial statements prepared by a potential financial statement preparation system according to an embodiment of the present invention.

FIG. 2 exemplifies shareholder-dedicated potential financial statements prepared by the potential financial statement preparation system of the embodiment.

FIG. 3 exemplifies manager-dedicated potential financial statements prepared by the potential financial statement preparation system of the embodiment.

FIG. 4 is a block diagram of the potential financial statement preparation system of the embodiment.

FIG. 5 exemplifies general financial statements conforming to the accounting principles.

### PREFERRED EMBODIMENTS OF THE INVENTION

Now, the present invention is more specifically described with reference to the accompanying drawings.

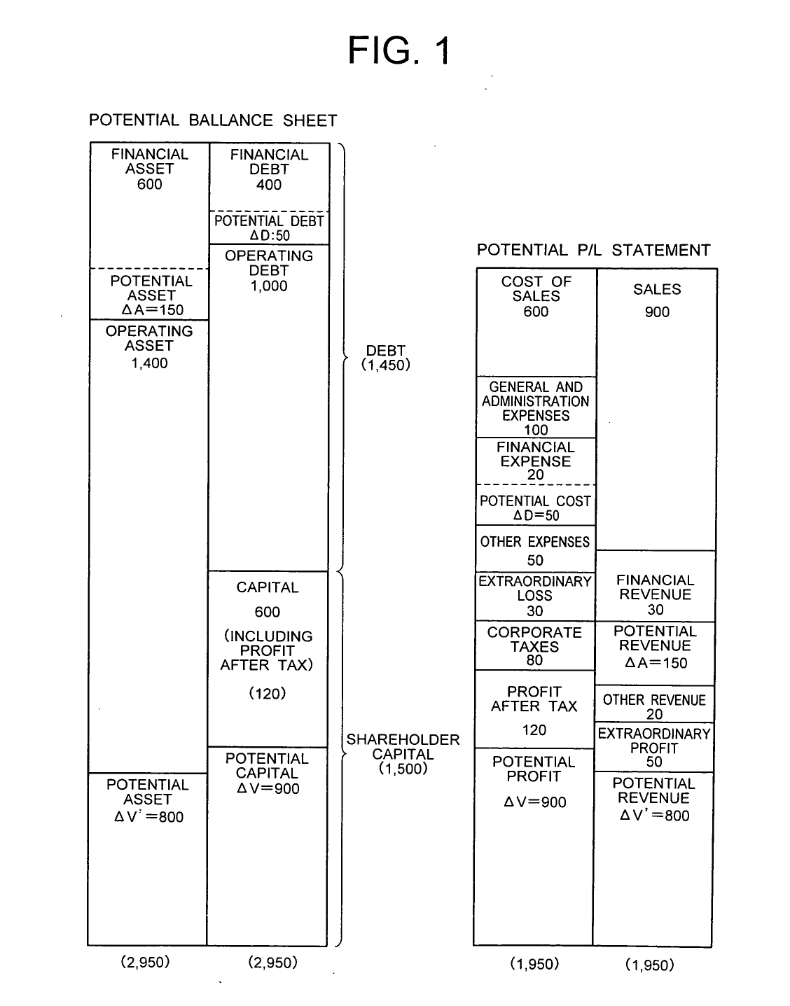

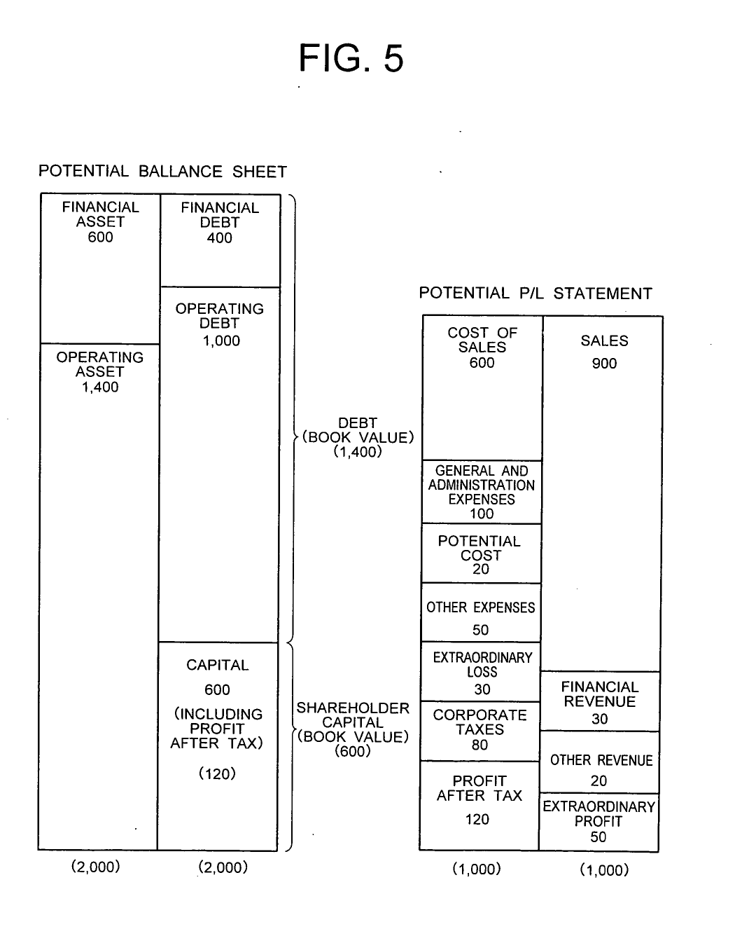

Referring to FIG. 1, there is shown creditor-dedicated potential financial statements prepared by a potential financial statement preparation system according to an embodiment of the present invention based on the financial statements conforming to the accounting principles and shown in FIG. 5. The creditor-dedicated potential financial statements include a potential balance sheet and a potential P/L statement, wherein the unit of numerals corresponds to ten thousand dollars, for example.

The creditor-dedicated balance sheet shown in FIG. 1 includes, on the debit side, a first potential asset ΔA=150 existing in the financial assets of the firm, and a second potential asset ΔV′=800 existing as viewed from the current value of the shareholder's capital (or shareholder's capital value), which are added to the debit side of the conventional balance sheet shown in FIG. 5. The creditor-dedicated balance sheet also includes, on the credit side, a potential debt ΔD=50 existing in the financial debt of the firm as viewed by the creditor, i.e., as viewed from the view point of the creditor, and a potential capital ΔV=900 existing in the shareholder's capital value, which are added to the credit side of the ordinary (conventional) balance sheet shown in FIG. 5. The addition of these values increases the total value of the firm by 950.

The creditor-dedicated P/L statement shown in FIG. 1 includes, on the debit side, a potential cost ΔD=50 existing in the financial debt of the firm and a potential profit ΔV=900 corresponding to the potential capital and existing in the shareholder's capital value, which are added to the ordinary P/L statement. The creditor-dedicated P/L statement also includes, on the credit side, a first potential revenue ΔA=150 corresponding to the potential asset existing in the financial assets and a potential revenue ΔV′=800 corresponding to the potential asset existing in the shareholder's capital value, which are added to the credit side of the ordinary P/L statement.

The financial debt of the firm is expressed in the book value DB thereof on the financial statements. The book value DB of the financial debt, which is associated with a contract interest rate, is different from the current value DA of the same financial debt, which current value DA depends on the current interest rate (or capital cost on the financial debt) of a possible new financial debt which the firm is now to raise. The term “potential debt” as viewed by the creditor is introduced herein, which corresponds to the difference between the current value DA of the financial debt and the book value DB thereof, the current value DA being calculated based on the capital cost of the possible financial debt, if raised by the firm at the present moment.

The current value DA of the financial debt as viewed by the creditor is calculated by the following formula:

$$DA = \frac{ca}{iD} \cdot DB$$

for the case without consideration of the tax; or

$$DA = \frac{( 1 + t ) ca}{iD} \cdot DB$$

for the case in consideration of the tax,
wherein DB, iD and ca are the book value of the financial debt, a possible interest rate required when the firm raises a fund in the market and referred to as “capital cost” of the financial debt, and the actual contract interest rate of the financial debt, respectively.

The above formula shows that the current value DA of the financial debt is obtained by multiplying the book value DB by the ratio of ca/ID or (1+t)·ca/iD. Thus, the difference ΔD between the current value DA of the financial debt as viewed by the creditor and the book value DB of the financial debt is calculated by the following formula:

$$Δ D = DA - DB = \frac{ca \cdot DB}{iD} - DB = \frac{ca - iD}{iD} \cdot DB \qquad ( 1 )$$

for the case without consideration of the tax, or

$$Δ D = \frac{( 1 + t ) ca - iD}{iD} \cdot DB \qquad ( 2 )$$

for the case in consideration of the tax.

If the difference ΔD as obtained above is a positive value, it is herein referred to as a potential cost relating to the financial debt, as viewed in the cost aspect of the financial statements. On the other hand, as viewed in the debt aspect thereof, it is referred to as a potential debt existing in the financial debt. As to the journal entry of the difference ΔD, it is introduced as a potential cost ΔD relating to the financial debt on the debit side of the potential P/L statement, and also introduced as a potential debt Δ D existing in the financial debt on the credit side of the potential balance sheet.

It is to be noted that, if the relationship ca<iD holds, or if the relationship (1+t)·ca<iD holds in the case of consideration of the tax, then the difference ΔD is negative and thus referred to as a potential revenue instead of the potential cost. In such a case, as to the journal entry, a potential debt ΔD relating to the financial debt is introduced on the debit side of the potential balance sheet, whereas a potential revenue ΔD existing in the financial debt is introduced on the credit side of the P/L statement. In this context, if the contract interest rate of the current financial debt is higher than the normal capital cost, i.e., the interest rate of a possible fund raised by the firm at the present moment, the current value DA of the financial debt is deemed higher than the book value of the financial debt by an amount corresponding to the difference between the contract interest rate and the normal capital cost. It is to be noted that the contract interest rate should be multiplied by (1+t) if the tax is considered.

Assuming that the financial revenue of the firm consists of an interest revenue, the current value ARA of the loan receivable is expressed by the following formula:

$$ARA = \frac{cb \cdot ARB}{rD} \qquad ( 3 )$$

wherein ARB, rD and cb are book value of the loan, capital cost of the loan, and contract interest rate of the loan, respectively. This formula shows that the current value of the financial asset is obtained by multiplying the book value of the financial asset by the ratio of cb/rD. As a result, the potential asset ΔA existing in the financial asset as a difference between the current value and the book value of the financial asset is calculated by the following formula:

$$Δ A = ARA - ARB = \frac{cb \cdot ARB}{rD} - ARB = \frac{cb - rD}{rD} ARB \qquad ( 4 )$$

If ΔA is positive, ΔA is referred to as a potential revenue relating to the financial asset on the revenue aspect, and also referred to as a potential asset existing in the financial asset on the asset aspect. As to the journal entry, the potential asset ΔA is introduced on the debit side of the balance sheet, whereas the potential revenue ΔA is introduced on the credit side of the potential P/L statement. It is to be noted that if the relationship cb<rD holds, then the difference ΔA is negative, and thus ΔA is referred to as a potential cost instead of the potential revenue. As to the journal entry in such a case, the potential cost ΔA of the financial asset is introduced on the debit side of the potential P/L statement, whereas the potential asset ΔA of the financial asset is introduced on the credit side of the potential balance sheet.

Current Value of the Shareholder's Capital

For evaluating the shareholder's capital value, a variety of known models such as discounted dividend model, discounted cash flow model, and residual income model can be used, among which the residual income model is used herein.

In the following description, variables b₀, r, RIᵢ, (i=0, 1, 2, 3, . . . ), Xᵢ, bᵢ represent book value of the shareholder's capital at the end of the zero-th term, rate of revenue required by the shareholder (i.e., capital cost), residual profit of the i-th term, profit after tax of the i-th term, and book value of the shareholder's capital at the end of the i-th term, respectively. It is to be noted that “r” is assumed a constant for all the terms, although r generally varies in fact from term to term with the economic atmosphere therein.

The current value V of the shareholder's capital considered in accordance with the residual income model is expressed by the following formula:

$$V = {b}_{0} + {\sum }_{l = 1}^{∞} \frac{{RI}_{i}}{{( 1 + r )}^{i}} \qquad ( 5 )$$

wherein RIᵢ=xᵢ−r·bᵢ₋₁.

The profit after tax (xᵢ) of the current term in the above formula is generally expressed by:
xᵢ=(1−t)·(ORᵢ+PPᵢ−PLᵢ)
wherein OPᵢ, PPᵢ and PLᵢ represent the ordinary profit, particular profit and particular loss, respectively, of the current (i-th) term, and “t” represents the effective tax rate. The right side of the equation is rearranged as follows:
xᵢ=MIᵢ+SIᵢ−SLᵢ,
wherein MIᵢ=(1−t)·OPᵢ, SIᵢ=(1−t)·PPᵢ, and SLᵢ=(1−t)·PLᵢ.

Here, B₀, Bᵢ, RIᵢ′ and RIᵢ are defined as follows:
B₀=b₀+ΔA−ΔD;
Bᵢ=bᵢ+ΔA−ΔD; and
RIᵢ′+SIᵢ−SLᵢ=xᵢ−r·Bᵢ₋₁=MIᵢ+SIᵢ−SLᵢ−r·Bᵢ₋₁.
Thus, RIᵢ′ is expressed by:
RIᵢ′=MIᵢ−r·Bᵢ₋₁
Formula (5) is then rewritten as follows:

$$V = {B}_{0} + {\sum }_{i = 1}^{∞} \frac{{RI}_{i}^{′} + {SI}_{i} - {SL}_{i}}{{( 1 + r )}^{i}} \qquad ( 6 )$$

wherein B₀ is calculated based on the book value b₀ of the shareholder's capital at the end of the zero-th term, the potential asset ΔA existing in the financial asset and the potential debt ΔD existing in the financial debt as follows:
B₀=b₀+ΔA−ΔD.

Thus, the potential capital ΔV of the shareholder's capital value is calculated as the difference between the current value V of the shareholder's capital expressed by the formula (6) and the book value of the shareholder's capital, and introduced on the credit side of the balance sheet. Accordingly, the potential asset ΔV′ is obtained by adding the potential debt ΔD existing in the financial debt as viewed by the creditor to the potential capital ΔV of the shareholder's capital and then subtracting therefrom the potential asset ΔA existing in the financial asset as follows:
ΔV′=ΔV−ΔA+ΔD.
The resultant potential asset ΔV′ relating to the shareholder's capital is introduced on the debit side of the balance sheet.

The resultant balance sheet, into which the potential asset ΔA existing in the financial asset, potential debt ΔD existing in the financial debt as viewed by the creditor, the potential capital ΔV existing in the shareholder's capital value and the potential asset ΔV′ relating to the shareholder's capital value are introduced as described above, is herein referred to as a creditor-dedicated potential balance sheet. On the other hand, the P/L statement, into which the potential revenue ΔA corresponding to the potential asset existing in the financial asset, the potential cost ΔD corresponding to the potential debt existing in the financial debt, the potential profit ΔV corresponding to the potential asset existing in the shareholder's capital value, and the potential revenue ΔV′ corresponding to the potential asset of the shareholder's capital are introduced corresponding to the creditor-dedicated potential balance sheet, is herein referred to as a creditor-dedicated potential P/L statement.

It is to be noted that the report form of the P/L statement including the sales and the cost of sales may be used for the potential P/L statement, although FIG. 1 shows the potential P/L statement in the account form. In addition, the potential P/L statement may be prepared by revealing the differences between the items of the potential balance sheet of the previous term and the respective items of the potential balance sheet of the current term.

The creditor-dedicated potential financial statements as described above provide information of the firm useful to the current creditor of the firm or a possible creditor who is scheduled to provide a fund to the firm in the near future, the information including an influence caused by the difference between the contract interest rates and the current capital costs of the financial debt and the financial asset, as well as the current value of the shareholder's capital of the firm. The potential financial statements including such information more reveal the situation of the firm to the creditors than the financial statements conforming to the accounting principles.

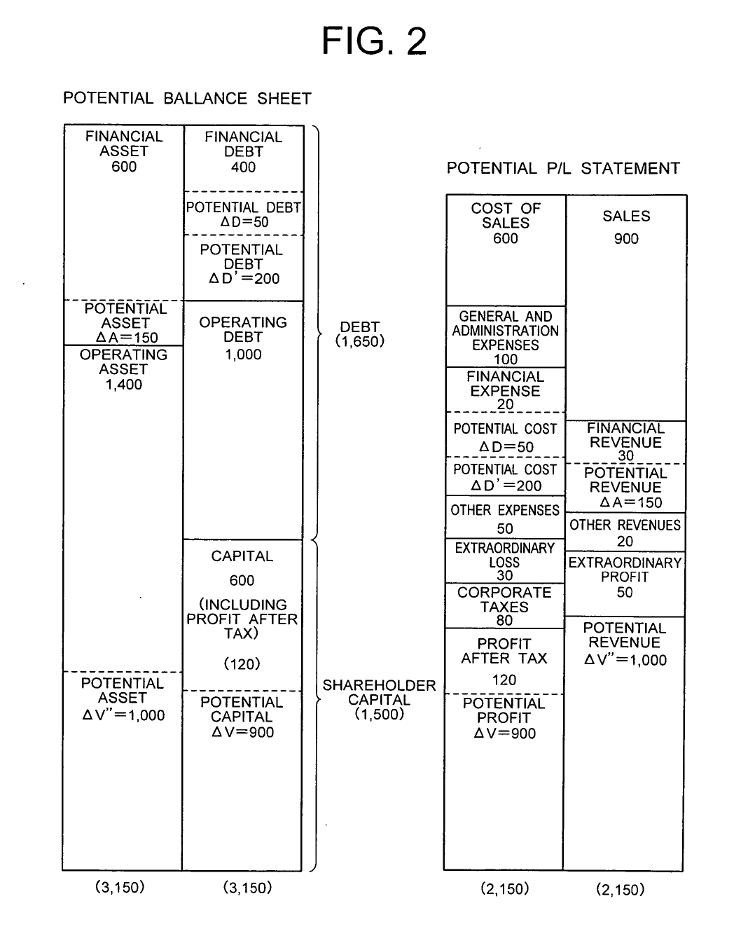

Referring to FIG. 2, there are shown exemplified shareholder(investor)-dedicated potential financial statements prepared by the potential financial statement preparation system of the present embodiment based on the conventional financial statements shown in FIG. 5. The unit of the numerals is ten thousand dollars, as well.

The shareholder-dedicated potential balance sheet shown in FIG. 2 includes, on the debit side thereof, a potential debt ΔV″=1000 existing in the shareholder's capital as viewed by the shareholder, instead of ΔV′ in the creditor-dedicated potential balance sheet shown in FIG. 1. The shareholder-dedicated potential balance sheet also includes, on the credit side thereof, a difference ΔD′=200 between the potential debt existing in the financial debt as viewed by the shareholder and the potential debt existing in the financial debt as viewed by the creditor, thereby increasing the total asset of the firm on the balance sheet. The shareholder-dedicated potential P/L statement of FIG. 2 also includes a potential cost ΔD′=200 which is added on the debit side to the creditor-dedicated P/L statement of FIG. 1, and includes a potential revenue ΔV″=1000 on the credit side instead of ΔV′=800 in FIG. 1.

For investigating the current value of the financial debt as viewed from the view point of the investor (shareholder), it is noted that the profit after tax of the current term of the firm belongs to the investor (shareholder) and is expressed by the following formula:
Pc=Pb+Po−Ei−Co−Ct
wherein Pc, Pb, Po, Ei, Co and Ct represent the profit after tax of the current term, operating profit, other profit, interest paid, other cost and tax, respectively. In the above formula, the profit Pc of the current term includes the interest expense Ei as a negative constituent thereof, revealing that the interest paid Ei is charged on the investor (shareholder). The interest paid Ei is expressed based on the contract interest rate “ca”, capital cost “iD” of the debt, which consists of a risk-free rate “if” and a portion “ir” of the interest rate corresponding to the risk of the creditor, book value “DB” of the debt and the current value “DA” of the debt as follows:
Ei=ca·DB=iD·DA=(if+ir)·DA. (7)

As understood from above, a portion (ir·DA) of the interest paid of the financial debt corresponding to the risk of the creditor is borne by the investor (shareholder). Accordingly, although the capital cost iD of the financial debt consists of “if” and “ir” (iD=if+ir) as viewed from the view point of the creditor, the capital cost (iD′) of the financial debt should consist of “if” excepting the risk as viewed by the investor (shareholder). In other words, the capital cost iD equals to if+ir from the view point of the creditor, whereas the capital cost iD equals to “if” from the view point of the shareholder. Thus, the current value DE of the financial debt as viewed by the shareholder is calculated by the following formula:

$$DE = \frac{ca \cdot DB}{if} = \frac{iD \cdot DA}{if} \qquad ( 8 )$$

for the case without consideration of the tax; and

$$DE = ( \frac{iD}{if} + t ) \cdot DA \qquad ( 9 )$$

for the case of consideration of the tax,
wherein DB, iD and if are the book value of the financial debt, capital cost of the financial debt and risk-free interest rate, respectively. It is to be noted here that the relationship iD=if+ir holds, wherein ir is a portion of the interest rate corresponding to the risk. Thus, the current value DE of the financial debt as viewed by the shareholder is different from the current value DA of the financial debt as viewed by the creditor, the difference ΔD′ therebetween being calculated by the following formula:

$$\begin{matrix}Δ {D}^{′} = DE - DA \\ = \frac{iD}{if} \cdot DA - DA \\ = \frac{iD - if}{if} DA \\ = \frac{iD - if}{if} \cdot \frac{ca}{iD} \cdot DB\end{matrix} \qquad ( 10 )$$

for the case without consideration of the tax, or

$$\begin{matrix}Δ {D}^{′} = DE - DA \\ = ( \frac{iD - if}{if} + t ) \cdot DA \\ = ( \frac{iD - if}{if} + t ) \cdot \frac{ca}{iD} \cdot DB\end{matrix} \qquad ( 11 )$$

for the case of consideration of the tax.

The difference ΔD′ corresponds to a difference between the potential debt existing in the financial debt as viewed by the shareholder and the potential debt existing in the financial debt as viewed by the creditor, and is referred to as a second potential cost in the cost aspect and a second potential debt in the debt aspect, if it is positive. For the journal entry, the second potential cost ΔD′ existing in the financial debt is introduced on the debit side of the potential P/L statement, whereas the second potential debt ΔD′ existing in the financial debt is introduced on the credit side of the potential balance sheet in addition to the first potential debt ΔD existing in the financial debt. As understood from this journal entry, the current value of the financial debt as viewed by the shareholder is ΔD′ larger than the current value of the financial debt as viewed by the creditor, the difference A D′ increasing the debit side of the potential balance sheet.

Current Value of the Shareholder's Capital

The potential asset A V″ existing in the shareholder's capital value as viewed by the investor (shareholder) in the shareholder-dedicated potential financial statements and the potential revenue ΔV″ corresponding thereto are larger than the potential asset ΔV′ existing in the shareholder's capital value and the potential revenue ΔV′, respectively, in the creditor-dedicated potential financial statements by a value corresponding to ΔD′.

The potential balance sheet as described above, wherein the potential asset ΔA, potential debt ΔD, potential debt ΔD′, potential asset ΔV″ and potential capital ΔV are introduced, is called herein a shareholder-dedicated potential balance sheet. It is to be noted that since there may be a firm having either one or none of the financial asset and financial debt, the potential balance sheet of such a firm includes one or none of the potential asset ΔA, ΔV′ and ΔV″ and potential debt ΔD and ΔD′. In such a case either, if the potential asset ΔA, ΔV′or ΔV″ or potential debt ΔD or ΔD′ does exist, the existence is reflected on the potential financial statements. Thus, it may be said that the potential financial statements prepared by the potential financial statement preparation system of the embodiment includes a potential asset and a potential debt added to the ordinary financial statements.

The total value of the shareholder-dedicated potential financial statement, wherein the potential revenue ΔA, potential cost ΔD, potential cost ΔD′ and potential profit ΔV are introduced, is ΔD′ larger than the total value of the creditor-dedicated potential financial statement. Although FIG. 2 shows the potential P/L statement in the balance form thereof, the potential P/L statement may be prepared in the report form including the sales and the cost of sales. In general, the potential debt ΔD as viewed by the creditor is smaller compared to the potential debt ΔD′ as viewed by the shareholder. It is reflected by the fact that there is only a small difference between ca and iD in the first terms of the right sides of the formulas (1) and (2) whereas if is considerably smaller than iD in the first terms of the right sides of the formulas (10) and (11). This means that the shareholder must invest on the firm after paying a careful attention to the risk rate of the financial debt of the firm, and the shareholder-dedicated potential balance sheet as described above is especially suited to this purpose.

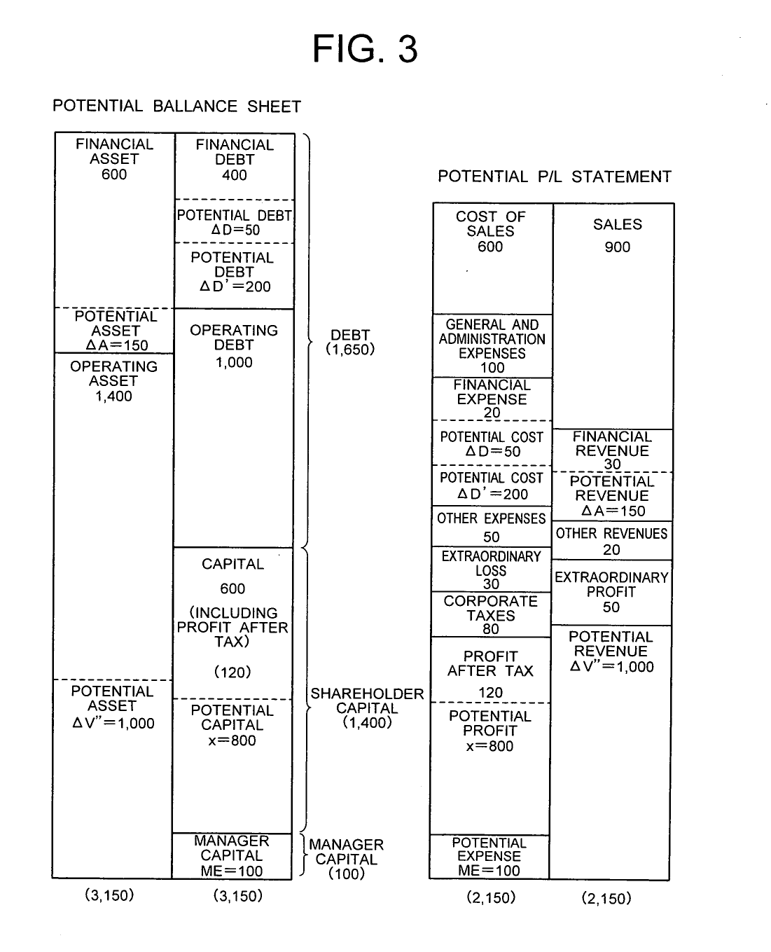

Referring to FIG. 3, there are shown exemplified manager-dedicated potential financial statements prepared by the potential financial statement preparation system of the present embodiment. The manager-dedicated potential financial statements are prepared by modifying the shareholder-dedicated potential financial statements to add thereto information relating to the ability of the manager. More specifically, the manager-dedicated potential financial statements separate the potential capital ΔV existing in the shareholder's capital value on the shareholder-dedicated potential financial statements into a first portion, potential capital portion x, relating to the shareholder's capital, and a second portion, manager capital ME. The other columns of the manager-dedicated potential financial statements are similar to those of the shareholder-dedicated potential financial statements. This expression on the manager-dedicated potential financial statements is devised based on the fact that if the manager contributes to a sufficient profit exceeding the profit expected by the investor (shareholder), a bonus will be paid to the manager for the reward by distribution of the profit under the judge by the shareholders.

The bonus to the manager and board members is paid from the profit or accumulated profits of the firm belonging to the shareholders and is determined to pay or not to pay based on the judgement by the shareholders from the view point of the shareholders. Thus, the bonus may be calculated by the formula without incurring a considerable problem to the shareholders in the estimation thereof. However, since the bonus to the manager etc., is a mere natural return of the acquisition of the sufficient profit for the effort by the manager etc., the manager-dedicated potential financial statements should reflect this fact. The manager-dedicated potential financial statements are obtained by modifying the shareholder-dedicated potential financial statements to reveal the fact, as will be described hereinafter.

If a residual income model is used for evaluation of the shareholder's capital value, the book value bi of the capital at the end of the i-th term of the firm is expressed by the following formula:
bᵢ=bᵢ₋₁+xᵢ−dᵢ (12)
In consideration of the fact that the bonus is paid to the manger etc. from the residual profit, the above formula (12) should be replaced by the following formula:
bᵢ=bᵢ₋₁+xᵢ−dᵢ−aᵢ (13),
wherein aᵢ is the bonus to the manager etc. It is assumed here that aᵢ is expressed by the following formula:
aᵢ=δ·RIᵢ₋₁,
that is, the bonus aᵢ is paid based on the constant percentage of the residual profit Rᵢ₋₁. Then, current value V of the shareholder's capital in the formula (5) can be expressed by the following formula:

$$V = {b}_{0} + {\sum }_{i = 1}^{∞} \frac{{RI}_{i} + {a}_{i}}{{( 1 + r )}^{i}} . \qquad ( 14 )$$

The formula is further modified as follows:

$$\begin{matrix}V = {b}_{0} + ∞ {\sum }_{i = 1}^{} \frac{{RI}_{i} - δ {RI}_{i - 1}}{{( 1 + r )}^{i}} \\ = {b}_{0} + \frac{{RI}_{1} - δ {RI}_{0}}{1 + r} + \frac{{RI}_{2} - δ {RI}_{1}}{{( 1 + r )}^{2}} + \frac{{RI}_{3} - δ {RI}_{2}}{{( 1 + r )}^{3}} + ⋯ \\ = {b}_{0} + \frac{{RI}_{1} - \frac{δ {RI}_{1}}{1 + r} + \frac{δ {RI}_{1}}{1 + r} - δ {RI}_{0}}{1 + r} + \\ \frac{{RI}_{2} - \frac{δ {RI}_{2}}{1 + r} + \frac{δ {RI}_{2}}{1 + r} - δ {RI}_{1}}{1 + r} + ⋯ \\ = {b}_{0} - \frac{δ}{1 + r} {RI}_{0} + \frac{{RI}_{1} - \frac{δ {RI}_{1}}{1 + r}}{1 + r} + \frac{{RI}_{2} - \frac{δ {RI}_{2}}{1 + r}}{{( 1 + r )}^{2}} + ⋯ \\ = {b}_{0} - \frac{δ}{1 + r} {RI}_{0} + {\sum }_{i = 1}^{∞} \frac{RIi - \frac{δ {RI}_{i}}{1 + r}}{{( 1 + r )}^{i}} + ⋯ \\ = {b}_{0} - \frac{δ}{1 + r} {RI}_{0} + ( 1 - \frac{δ}{1 + r} ) {\sum }_{i = 1}^{∞} \frac{{RI}_{i}}{{( 1 + r )}^{i}} + ⋯\end{matrix}$$

Thus, the formula:

$$V = b0 + {\sum }_{i = 1}^{∞} \frac{{RI}_{i}}{{( 1 + r )}^{i}} - \frac{δ}{1 + r} {\sum }_{i = 1}^{∞} \frac{{RI}_{i - 1}}{{( 1 + r )}^{i - 1}} \qquad ( 15 )$$

is obtained.

The first and second terms of the right side of the formula (15) represent the shareholder's capital value VB in the creditor- and shareholder-dedicated potential financial statements, and the whole of the right side represents the original value of the shareholder's capital. Thus, the third term of the right side is construed as the manager capital ME, whereby the following formula:

$$ME = \frac{δ}{1 + r} {\sum }_{i = 1}^{∞} \frac{{RI}_{i - 1}}{{( 1 + r )}^{i - 1}} \qquad ( 16 )$$

is obtained.

The manager-dedicated potential financial statements reveal the manager capital by adding the potential cost ME relating to the manager capital, represented by the formula (16), on the debit side and the manager capital ME itself on the credit side. The resultant manager-dedicated potential financial statements demonstrate the contribution by the manager, thereby allowing the shareholders to accept the contribution by the manager.

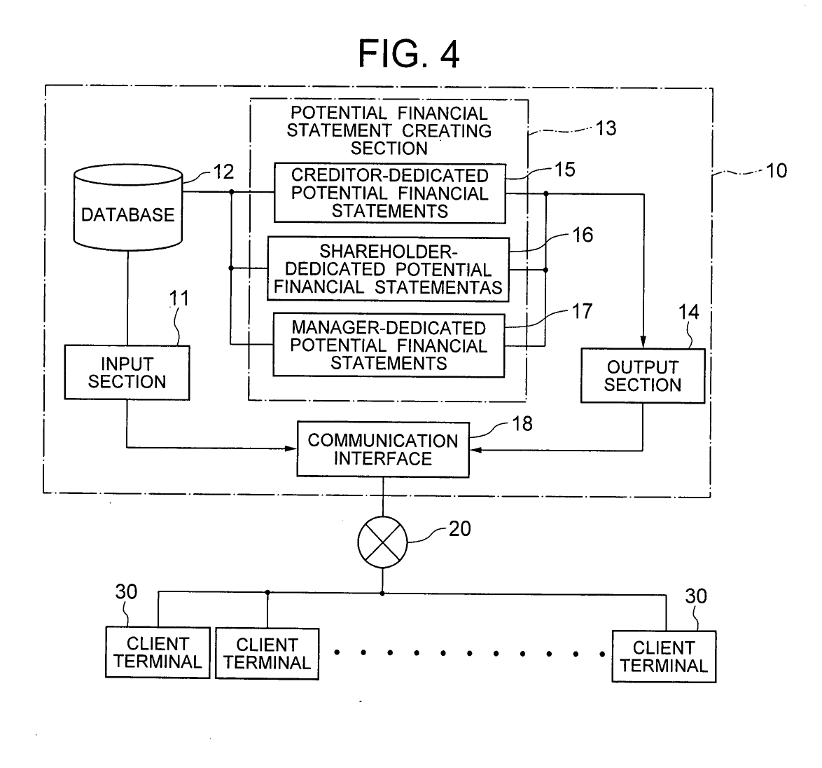

Referring to FIG. 4, there is shown a functional block diagram of the potential financial statement preparation system of the present embodiment. The potential financial statement preparation system 10 is connected to a plurality of client terminals 30 via a communication network 20 such as the internet. The potential financial statement preparation system 10 includes an input section 11 for receiving data including the information of the ordinary financial statements of firms, a database 12 for storing data including the received ordinary financial statements and potential financial statements prepared in the system 10, a potential financial statement creation section 13, i.e., information processing section, for creating the potential financial statements based on the ordinary financial statements and other information, an output section 14 for transmitting data of the potential financial statements to the client terminals 30, and a communication interface 18 for connecting the system 10 to the communication network 20.

The clients of the system 20 encompass all the interested persons of the subject firm in the wide sense thereof, including the firm itself, a creditor having a financial credit thereon, a financial institution asked by the firm to provide a fund thereto, a current shareholder of the firm, a person wishing to invest on the firm now or in the future, an investing company, economic analyst, and the manager, board members and employees of the firm.

The input section 11 receives data input by the operator of the system 10 and data including the past and latest ordinary financial statements as well as necessary data from the client terminals 30 including computers of the firms through the communication interface 30, storing the received data in the database 12. The data stored in the database 12 are retrieved therefrom by the potential financial statement creation section 13. The information of a firm includes the interest rate of the financial debt, interest rate of the loan receivable, capital cost or current interest rate required of the firm to raise a fund, expected interest rate in the future, estimated profits such as the ordinary profit, ratio of the bonus of the board members to the residual profit in the past etc.

The potential financial statement creation section 13 includes a first block 15 for creating the creditor-dedicated potential financial statements based on the ordinary financial statements (or data thereof available to the system 10; the same applies to other blocks) and other information of the firm, a second block 16 for creating the shareholder-dedicated potential financial statements based on the ordinary financial statements and the other information of the firm, and a third section for creating the manager-dedicated financial statements based on the ordinary financial statements and the other information of the firm. Each of the first through third blocks 15 to 17 can deliver the own potential financial statements to the client terminals 30 through the communication interface 18 and the communication network 20.

In one case, the potential financial statement preparation system 10 of the present embodiment receives requests from the clients such as a shareholder or creditor through the client terminals 30 to prepare the potential financial statements based on the ordinary financial statements and the information of the firm, providing the resultant potential financial statements to the clients. In another case, the potential financial statement preparation system 10 receives confidential information of the firm from an economic analyst, for example, to modify the current potential financial statements, providing the analyst-dedicated potential financial statements to the economic analyst. In another case, the potential financial statement preparation system 10 periodically receives the ordinary financial statements and other information of the firm, if the subject firm is a major company, preparing the creditor- or shareholder-dedicated potential financial statements and regularly providing the same to the client terminals 30 of the clients, such as an economic analyst, having contracts with the owner of the system 10.

Since the above embodiments are described only for examples, the present invention is not limited to the above embodiments and various modifications or alterations can be easily made therefrom by those skilled in the art without departing from the scope of the present invention.

1. A potential financial statement preparation system comprising:
an input section for receiving information of ordinary financial statements of a firm conforming to accounting principles and other information of the firm; and
an information processing section for adding, to said ordinary financial statements, at least a potential debt ΔD existing in a financial debt, a potential asset ΔA existing in a financial asset, a potential capital ΔV existing in a shareholder's capital value, and a potential asset ΔV′ existing in said shareholder's capital value, each of which exists as viewed by a creditor and is calculated based on said ordinary financial statements and said other information, to thereby prepare first potential financial statements.

2. The potential financial statement preparation system according to claim 1, wherein said information processing section adds, to said ordinary financial statements, at least a potential debt (ΔD+ΔD′) existing in said financial debt as viewed by a shareholder, said potential asset ΔA, said potential capital ΔV, and a potential asset ΔV″ existing in said shareholder's capital value as viewed by the shareholder, to thereby prepare a second potential financial statements.

3. The potential financial statement preparation system according to claim 2, wherein said information processing section adds, to said ordinary financial statements, at least said potential debt (ΔD+ΔD′), said potential asset ΔA, said potential asset ΔV″, and first and second portions (x) and (ME) of said potential capital ΔV relating to said shareholder's capital and a manager capital, respectively, which are calculated based on said ordinary financial statements and said other information, to thereby prepare a third potential financial statements.

4. The potential financial statement preparation system according to claim 2, wherein said information processing section calculates:
said potential debt ΔD by the following formula:
$$Δ D = \frac{ca - iD}{iD} \cdot DB or Δ D = \frac{( 1 + t ) ca - iD}{iD} \cdot DB$$
wherein “DB”, “ca”, “iD” and “t” represent a book value of said financial debt, a contract interest rate of said financial debt, a current ordinary interest rate for the firm, and an effective tax rate, respectively;
said potential asset ΔA by the following formula:
$$Δ A = \frac{cb - rD}{rD} \cdot ARB$$
wherein “ARB”, “cb” and “rD” represent a book value of said financial asset, a contract interest rate of said financial asset and a current ordinary interest rate of the financial asset of the firm, respectively;
said potential asset ΔV′ by the following formula:
ΔV′=ΔV−ΔA+ΔD; and
said potential asset ΔV″ by the following formula:
ΔV″=ΔV−ΔA+ΔD+ΔD′.

5. The potential financial statement preparation system according to claim 4, wherein said information processing section calculates said potential debt (ΔD+ΔD′) by the following formula:
$$Δ D + Δ {D}^{′} = \frac{ca - iD}{iD} \cdot DB + \frac{iD - if}{if} \cdot \frac{ca}{iD} \cdot DB ; or$$
$$Δ D + Δ {D}^{′} = \frac{( 1 + t ) ca - iD}{iD} \cdot DB + ( \frac{iD - if}{if} + t ) \cdot \frac{ca}{iD} \cdot DB$$
wherein “if” represents a risk-free interest rate.

6. The potential financial statement preparation system according to claim 4, wherein said information processing section calculates said manager capital ME by the following formula:
$$ME = \frac{δ}{1 + r} {\sum }_{i = 1}^{∞} \frac{{RI}_{i - 1}}{{( 1 + r )}^{i - 1}} .$$

7. The potential financial statement preparation system according to claim 1, further comprising an output section for transmitting data of said first potential financial statements to a plurality of client terminals via a communication network, wherein said input section receives said other information from one of said client terminals via a communication network.

8. A potential financial statement preparation system comprising:
an input section for receiving information of ordinary financial statements of a firm conforming to accounting principles and other information of the firm; and
an information processing section for adding, to said ordinary financial statements, at least a potential debt (ΔD+ΔD′) existing in a financial debt, a potential asset ΔA existing in a financial asset, a potential capital ΔV existing in a shareholder's capital value and a potential asset ΔV″ existing in said shareholder's capital value, each of which exists as viewed by a shareholder and calculated based on said ordinary financial statements and said other information, to thereby prepare potential financial statements.

9. The potential financial statement preparation system according to claim 8, further comprising an output section for transmitting data of said potential financial statements to a plurality of client terminals via a communication network, wherein said input section receives said other information from one of said client terminals via a communication network.

10. A potential financial statement preparation system comprising:
an input section for receiving information of ordinary financial statements of a firm conforming to accounting principles and other information of the firm; and
an information processing section for adding, to said ordinary financial statements, at least a potential debt (ΔD+ΔD′) existing in a financial debt, a potential asset ΔA existing in a financial asset, a potential asset ΔV″ existing in said shareholder's capital value, each of which exists as viewed by a shareholder and calculated based on said ordinary financial statements and said other information, and first and second portions (x) and (ME) of a potential capital ΔV existing in a shareholder's capital value as viewed by the shareholder and calculated based on said ordinary financial statements and said other information, said first and second portions relating to said shareholder's capital and a manager capital, to thereby prepare potential financial statements.

11. The potential financial statement preparation system according to claim 10, further comprising an output section for transmitting data of said potential financial statements to a plurality of client terminals via a communication network, wherein said input section receives said other information from one of said client terminals via a communication network. plurality of client terminals via a communication network, wherein said input section receives said other information from one of said client terminals via a communication network.
